(19) United States
(12) Patent Application Publication
(10) Pub. No.: US 2026/0126793 A1
(43) Pub. Date: May 7, 2026

(54) Lightweight Flight Control System for Miniature Indoor Aerial Robots

(71) Applicant: Georgia Tech Research Corporation, Atlanta, GA (US)

(72) Inventors: Qiuyang Tao, Atlanta, GA (US); Tony X. Lin, Atlanta, GA (US); Junkai Wang, Atlanta, GA (US); Zheyuan Xu, Atlanta, GA (US); Fumin Zhang, Atlanta, GA (US)

(21) Appl. No.: 18/947,957

(22) Filed: Nov. 14, 2024

Related U.S. Application Data
(63) Continuation-in-part of application No. 17/524,182, filed on Nov. 11, 2021, now abandoned.
(60) Provisional application No. 63/112,467, filed on Nov. 11, 2020.

(51) Int. Cl. G05D 1/225; B64U 10/13; G05D 1/249; G05D 109/25; G05D 111/10

(52) U.S. Cl. CPC G05D 1/225; B64U 10/13; G05D 1/249; G05D 2109/254; G05D 2111/10

(57) ABSTRACT

A robotic system includes a robot, a motion capture system and a ground station. The robot includes motors, a transceiver, an actuation circuit that receives an actuation command data packet from the transceiver and controls actuation of the motors. The motion capture system tracks a position and attitude of the robot and generates position and attitude data. The ground station is in wireless data communication with the transceiver and is in data communication with the motion capture system. The ground station receives the position and attitude data from the motion capture system; calculates a desired actuation for the robot; generates actuation command data packets for effecting the desired actuation. The actuation command data packets are transmitted wirelessly to the robot transceiver. The robot actuates the plurality motors upon receiving the actuation command data packet.

### CROSS-REFERENCE TO RELATED APPLICATION(S)

This application is a Continuation-in-Part of U.S. patent application Ser. No. 17/524,182, filed Nov. 11, 2021, which claims the benefit of U.S. Provisional Patent Application Ser. No. 63/112,467, filed Nov. 11, 2020, the entirety of each of which is hereby incorporated herein by reference.

### STATEMENT OF GOVERNMENT SUPPORT

This invention was made with government support under grant number 1828678, awarded by the National Science Foundation; grant number N0014-19-1-2266, awarded by the Office of Naval Research; and grant number A9550-19-1-0283, awarded by the Air Force Office of Scientific Research. The government has certain rights in the invention.

### BACKGROUND OF THE INVENTION

### 1. Field of the Invention

The present invention relates to robots and, more specifically, to a system for controlling robots.

### 2. Description of the Related Art

Indoor aerial robots are finding an increasing number of applications, including sensing features of interior spaces. Such sensing can include photography and videography of the interiors of such things as storage tanks and structural voids. Other types of sensing are also being used. Many indoor aerial robots include miniature propeller driven drones that are powered by batteries and have sensors attached thereto.

Minimizing avionics weight is a major challenge when trying to ensure miniature aerial robots achieve a compact form capable of fulfilling the necessary requirements of endurance, actuation, computation, and expandability. Payload limitations of a miniature aerial robot are closely related to the flight endurance of the robot, as reducing payload weight in exchange for a larger battery can increase the flight time of the aerial robot. The challenge is further escalated by the requirement for better maneuverability. Multiple thrusters, their mechanical support and driving electronics have to be implemented with minimum weight while still providing adequate propulsion. Consistency of the actuation is also required among varying battery levels (which occurs as the battery becomes discharged). Also, many functionalities of aerial robots, such as computer vision, require intensive computational effort that requires the use of additional payload and energy when implemented onboard.

Therefore, there is a need for an off-board aerial robot control system in which communications have a low latency and high update rate.

### SUMMARY OF THE INVENTION

The disadvantages of the prior art are overcome by the present invention which, in one aspect, is a robotic system that includes a first robot, a motion capture system and a ground station. The first robot includes a plurality of motors, a robot transceiver, a motor actuation circuit that receives an actuation command data packet from the robot transceiver and that controls actuation of the plurality of motors based on the actuation command data packet received from the robot transceiver. The motion capture system tracks a position and attitude of the first robot within a coordinate system and that generates position and attitude data representative thereof. The ground station is in wireless data communication with the robot transceiver of the first robot and is in data communication with the motion capture system. The ground station is configured to: receive the position and attitude data from the motion capture system; calculate a desired actuation for the first robot; generate the actuation command data packet to include actuation commands for effecting the desired actuation; and transmit the actuation command data packet wirelessly to the robot transceiver of the first robot. The first robot actuates the plurality motors upon receiving the actuation command data packet.

In another aspect, the invention is an aerial robotic control system for controlling a plurality of aerial robots that each includes a plurality of thrusters, a robot transceiver, a thruster actuation circuit that receives an actuation command data packet from the robot transceiver and that controls actuation of the plurality of thrusters based on the actuation command data packet received from the robot transceiver. The aerial robotic control system includes a motion capture system that tracks a position and attitude of each aerial robot of the plurality of aerial robots within a coordinate system and that generates position and attitude data representative thereof. A ground station is in wireless data communication with each robot transceiver of the plurality of aerial robots and is in data communication with the motion capture system. The ground station is configured to: receive the position and attitude data from the motion capture system; calculate a desired actuation for each aerial robot; generate the actuation command data packet to include actuation commands that effect the desired actuation; and transmit the actuation command data packet wirelessly to the robot transceiver of each of the plurality of aerial robots. Each of the plurality of aerial robots actuates the plurality thrusters upon receiving the actuation command data packet.

In yet another aspect, the invention is a robotic system that includes a first robot, a motion capture system, a ground station, a core electronics board and a power module. The first robot includes a plurality of motors, a robot transceiver and a battery. The motion capture system tracks a position and attitude of the first robot within a coordinate system and generates position and attitude data representative thereof. The ground station includes a computer that is in wireless data communication with the robot transceiver of the first robot and is in data communication with the motion capture system. The ground station is configured to: receive the position and attitude data from the motion capture system; cause the computer to calculate a desired actuation for the first robot; cause the computer to generate the actuation command data packet to include actuation commands for effecting the desired actuation; and transmit the actuation command data packet wirelessly to the robot transceiver of the first robot. All real-time flight controllers are disposed on the ground station and not on the first robot. The computer is programmed to calculate all motor voltage values necessary to accomplish a maneuver and transmit them to the robot transceiver. The core electronics board is affixed to the first robot and includes: an advanced RISC machine (ARM) processor that is responsive to the robot transceiver and a plurality of motor controllers. The advanced RISC machine (ARM) processor receives the motor voltage values from the ground station and is programmed to determine to which motor each voltage value is to be assigned. Each of the plurality of motors is electrically coupled to the advanced RISC machine (ARM) processor and is electrically coupled to one of the plurality of motor controllers. The advanced RISC machine (ARM) processor transmits a voltage value assigned to a selected motor to the one of the plurality of motor controllers electrically coupled to the selected motor. The one of the plurality of motor controllers electrically coupled to the selected motor applies an activating voltage corresponding to the voltage value directly to one of the plurality of motors. The power module provides constant voltage to the entire first robot when voltage from the battery varies over time.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram showing the major components and workflow of the overall system in which solid arrows denote wired connections.

FIG. 2 is a schematic diagram showing one embodiment of a ground station transceiver.

FIG. 3A is a schematic diagram showing one embodiment of a core electronics board.

FIG. 3B is a schematic diagram showing one embodiment of the motor actuator portion of the core electronics board.

FIG. 4 is a diagram showing a representative waveform of the control command signal received by the ground station and a corresponding motor terminal voltage.

FIG. 5 is a diagram showing amplitude of wireless data packets between an aerial robot and a ground station.

FIG. 6 is a photograph showing a size comparison of the electronic components of one embodiment and a quarter.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on. ”

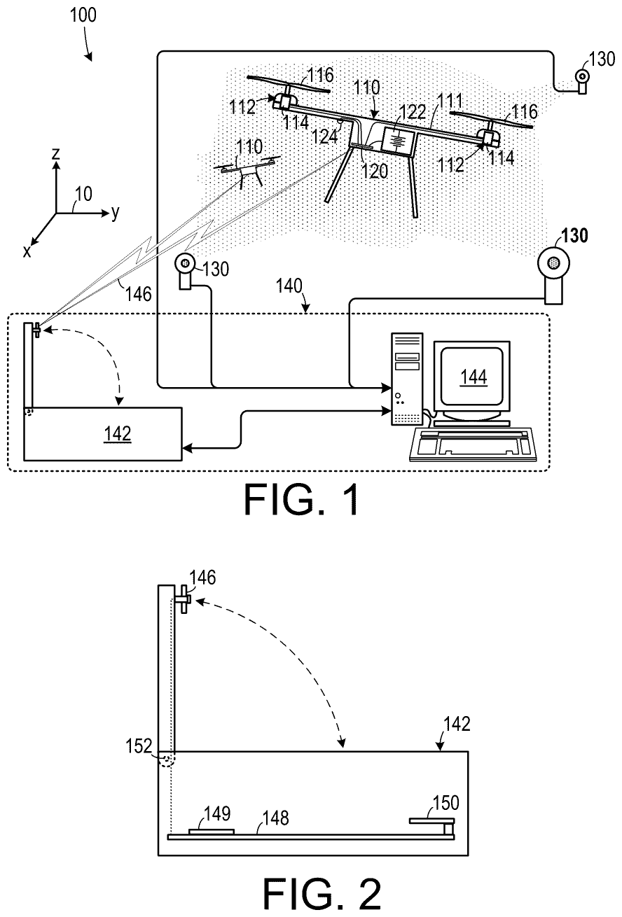

As shown in FIG. 1, one embodiment of a robotic control system includes a ground station 140, one or more robots 110 (such as a plurality of aerial robots), and a motion capture system 130 (such as an indoor motion capture system). The ground station is built around a generic computer 144 that directly interfaces with the motion capture system 130 and a ground station transceiver 142. The computer 144 hosts flight control software, processes computationally intensive tasks, and communicates with the robot(s) 110 wirelessly through the ground station transceiver 142. The ground station 140 can support several robots 110 simultaneously, enabling cooperative behaviors in multi-robot swarm applications.

The robot 110 includes a chassis 111 upon which is mounted a battery 122, a plurality of thrusters 112 and a control circuit 120. The control circuit includes a robot transceiver circuit for receiving actuation command data from the ground station 140, a motor actuation circuit for controlling the thrusters 112 and may also include a circuit for receiving sensor data from a sensor 124 (e.g., a digital camera, temperature sensor, a humidity sensor, a radiation sensor, etc.) and transmitting the sensor data to the ground station 140. In an aerial robot configuration, each thruster 112 includes an electric motor 114 that is powered through the control circuit in an on-board electronics suite 120 and a propeller 116 that is driven by the motor 114. When the on-board electronics suite 120 receives an actuator command data packet from the ground station 140, it directly transforms the data therein into a voltage signal that actuates the motor 114 that is the subject of the data packet. All computationally intense calculations are done by the computer 144, thereby reducing the functionality required by the on-board electronics suite 120 and thus reducing the weight and electrical requirements of the on-board electronics suite 120. This frees up battery power for the thrusters 112.

Due to its off-board control scheme, the control system embodied in the ground station 140 uses a workflow that employs the following three major steps:
(1) The motion capture system 130 (which can use commercially available devices, such as motion capture cameras—which in one experimental embodiment were Optitrack Flex13 motion capture cameras available from NaturalPoint, Inc., Corvallis, OR) tracks the position and attitude of the robot at high frame rates (e.g., at least 100 frames per second) and sends the measurement to the ground station computer 140. This information is referred to as the “pose information,” which indicates the position and orientation of the robot 110 relative to a predetermined coordinate system 10.
(2) Once the pose information is ready, the flight control software running on the ground station computer 144 calculates the desired actuation and encapsulates the controller outputs into actuation command data packets. The ground station transceiver 142 receives the data packets from the computer 144 and then sends the control commands to the robot 110 wirelessly.
(3) The robot 110 updates the actuation of the corresponding thrusters upon the reception of the control commands. Also, data from onboard sensor(s) 124 can be transmitted back to the ground station 140 through a wireless link 146.

As shown in FIG. 2, one representative embodiment of the ground station transceiver 142 includes a main circuit board 148 and a radio frequency antenna 146 that is electrically coupled thereto. The antenna 146 can be foldable by rotating on a pivot 152 to facilitate easy storage. An optional USB interface board 150 can be plugged into the main circuit board 148 and can be used to interface with the computer 144 via a USB cable. The main circuit board 148 includes a ground station transceiver circuit 149 for modulating commands from the computer 144 onto a radio frequency signal. It also parses the control commands from the ground station computer 144, checks the integrity of the commands, and communicates with the aerial robot 110 wirelessly via the antenna 146. The external antenna 146 enhances the signal transmission and reception and can feature a foldable design for portability. The transceiver circuit 149 communicates with the ground station computer 144 by employing asynchronous serial communication. The optional USB interface board 150 can be installed inside the transceiver 142 device for computers that do not have an UART (universal asynchronous receiver-transmitter).

In one experimental embodiment, the transmission power of the wireless link between the ground station transceiver 142 and the aerial robot 110 was +8 dBm for extended range and showed improved reliability. The data rate for the bi-directional wireless communication in this embodiment was 2 Mbps, which was adequate for outbound control from the ground station and inbound sensing from the aerial robot 110.

Returning to FIG. 1, the onboard electronics suite 120 on the robot 110 can include a core electronics board and an optional power module. These devices are designed with an emphasis on compactness to reserve payload for actuators, battery, structure, and mission-related devices such as sensors. In one experimental embodiment, the core electronics board weighted 0.49 grams, the power module if configured for 10 W was 0.63 grams and if configured for 20 W was 2.60 grams. The core electronics board had an area of about 2 cm².

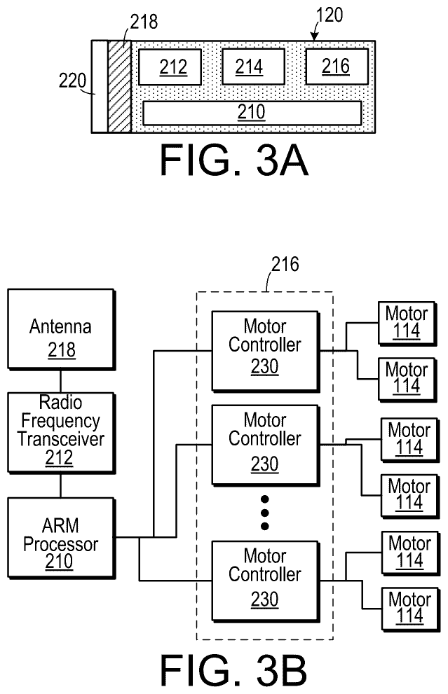

As shown in FIGS. 3A and 3B, the core electronics board 120 of the robot 110 employs a compact integration of all essential functionalities. Components can include an advanced RISC machine (ARM) processor 210, drivers 216 for each of the motors (six motors were used in one experimental embodiment), a voltage regulator 214, a multi-functional connector 220, a wireless transceiver 212 and an antenna 218. The experimental embodiment featured a high power density, yielding a maximum power output of 50 W, which is more than enough for a wide range of miniature robots.

The drivers 216 include a plurality of motor controllers (DRV8835 Dula Low-Voltage H-Bridge IC Motor Drivers available from Texas Instruments, in which a single controller can drive two different motors). In operation, the ground station 142 calculates all motor voltage values necessary to accomplish a maneuver and then transmits the voltage values directly to the core electronics board 120. The ARM processor 210 determines to which motor each voltage value is to be assigned and then transmits the voltage values to the corresponding motor controller 230, which then applies the activating voltage directly to the motor 114.

The power module provides constant voltage to the entire robot despite the varying battery voltage over time. This device improves the consistency of the motor actuation among varying battery levels (which occurs as the battery becomes depleted). Two experimental versions with power outputs of 10 watts and 20 watts were developed. The power module with the 10W output was sufficient for many operating scenarios and task payloads of miniature robots. The module with the 20W output was developed for high-power task payloads and extended operating conditions. DC-to-DC converters with high switching frequency were incorporated for high efficiency and reduced weight.

The flight control system features a low-latency offboard control scheme, which allows implementation of real-time flight controllers on the ground station instead of onboard the robot.

Benefits of off-board computation include convenient accessibility to indoor localization systems, support for computationally-intensive algorithms, reduced size and power consumption, and convenience for development and post analysis.

Due to the GPS-denied environment, an indoor motion capture system is usually required for the miniature aerial robots. A powerful computer is important for calculating the pose of the robot. It has been found that implementing the flight controller on the same ground station computer allows for the most convenient access and minimum latency connection to the localization system.

The onboard computational power for many small-sized robots is limited due to constraints such as energy consumption and weight. As a result, computationally intensive algorithms such as model-predictive control (MPC) and computer vision usually cannot be implemented onboard. On the other hand, there is no such limitations when these computations are performed on the ground station computer of the present invention. Additionally, the development, debugging, and data logging are more convenient on the ground computer.

Off-board computation requires minimization of the communication latency between the aerial robot and the ground station. The control command computed by the ground station computer needs to be first sent to the aerial robot wirelessly and then executed by the onboard electronics to drive the actuators. Low latency is also important for control of fast roll and pitch dynamics. The off-board control scheme is developed with the goal of low latency, high update rate, low power consumption, and good reliability. Local area wireless networks (such as Bluetooth and Zigbee) can be employed indoor robotic platforms due to their convenience of implementation. However, the latency of these communication technologies is usually over 15 ms, making them less desirable for off-board control. Also, a substantial amount of computation is required for the protocol stack, which causes extra power consumption.

The core electronics board 120 can be conveniently reprogrammed for expanded functionality with the programming adapter. On the same plot, a carrier adapter can also be used for testing and debugging. The two devices can be conveniently mated with the core electronics board with a single multipurpose connector.

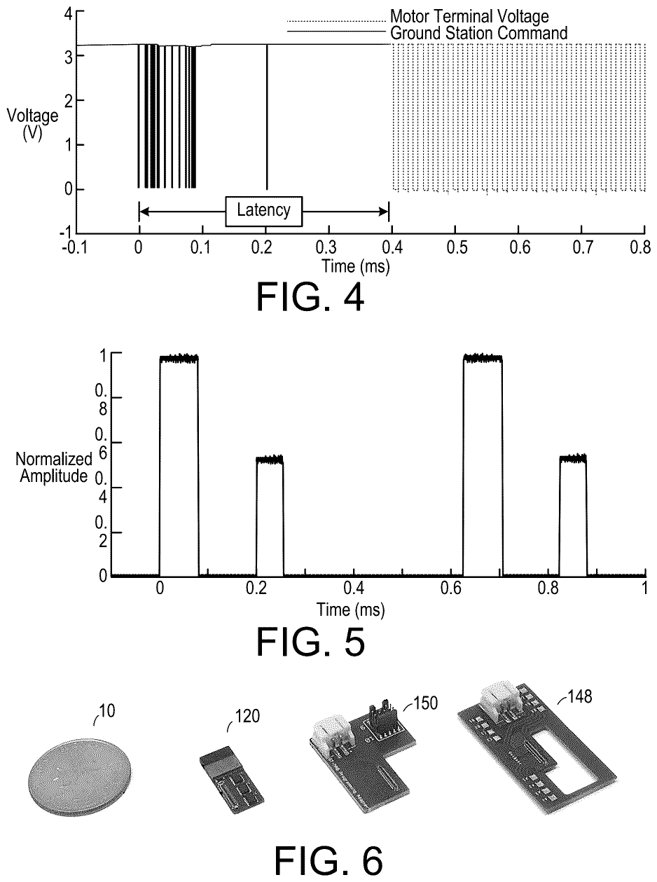

The present invention minimizes the length of the control command and incorporated a basic radio-frequency (RF) transceiver without a heavy protocol stack for lower latency. As shown in FIG. 4, the waveform of the control command signal received by the ground station demonstrates low-latency feature of the off-board control scheme. It takes an average of 387μs to update the terminal voltages of the onboard thrusters after the controller outputs are received by the ground station transceiver in the experimental embodiment. As demonstrated in FIG. 5, which shows the wireless data packets between the aerial robot and the ground station, the core electronics board functions like a transponder for the convenience of time synchronization and fail-safe protection. Two bi-directional communications can be accomplished within l ms. Upon the reception of the control command from the ground station, the onboard electronics immediately executes the command and sends sensor data back. A zero-order-hold is implemented in the case of corrupted or missing packets. For safety reasons, actuators can be turned off when no valid packet is received after half a second. To reduce potential interference, the frequency range should be selected to be outside that of Wi-Fi or Bluetooth devices. Also shown in FIG. 5, the bi-directional communication between the aerial robot and the ground station supports update rate up to 2000 Hz. When operated at maximum update rate with transmission power of +8 dBm, the overall power consumption of the gondola is only less than 50 mW. With low latency, high update rate, and low power consumption, the off-board control scheme can fulfil the requirements of most miniature aerial robots, as well as many other robotic platforms.

As shown in FIG. 6, the core electronics board 120 can be fabricated to be smaller than a quarter 10. The main circuit board 148 and the optional USB interface board 150 can also be made with a reduced form factor.

The onboard electronics of the flight control system disclosed herein features a compact design. The lightweight feature of the onboard electronics suite reserves valuable payload capacity of miniature robots for actuators, battery, structure, and mission-related devices, such as sensors. The core electronics board is a compact integration of all essential functionalities of the aerial robot.

The off-board control scheme automatically checks the integrity of the control commands and will turn off all actuators if no valid command is received for over half a second. Wireless communication between the aerial robot and the ground station operates outside the WiFi and Bluetooth bands, which minimizes potential radio interference. Experimental results indicate that the bidirectional wireless link can retain its functionality in close proximity to Bluetooth devices, WiFi routers, and wireless cameras that operate at 2.4 GHz, 5 GHz, and 5.8 Ghz bands.

The flight control system features a modular design. The core electronics board integrates all essential functionalities, while the remaining part of the aerial robot provides only mechanical support, basic electrical connections, and task-related functionalities. The core electronics board can be conveniently mated with the robot chassis via a single multipurpose connector. The modular design simplifies the assembly, maintenance, and future improvement of the aerial robot system.

The system features light weight, low energy consumption and high output power density. These features are especially favorable for miniature aerial robots, which usually have compact sizes and strict payload limitations. Miniature indoor ground robots could also benefit from the present invention. The monolithic design of the core electronics board could simplify the design of existing small-sized ground robots. While being targeted for indoor applications, the flight control system of the present invention can also be deployed on small outdoor robots. With integrated wireless communication and high output power density, potential outdoor applications include small-sized drones, rovers and autonomous boats. The flight control hardware of this invention can also support Bluetooth, which provides a convenient connectivity to smartphones. Therefore, the core electronics board can be deployed on remotely-controlled devices (such as toys) and the user can send a control signal via smartphone. This simplifies the design of RC toys and reduces cost by eliminating the need for a dedicated handheld controller.

The present invention includes a light-weight flight control system which reserves the limited payload of miniature aerial robots to address the payload requirements associated with batteries, actuation, supporting structures, and mission tasks. The core electronics board integrates all essential functionalities of the robot and weighs only less than half a gram. The flight control system also features a unique low-latency off-board control scheme that is specifically suitable for indoor aerial robots. The scheme reduces onboard power consumption and allows computationally intensive algorithms to be executed on the ground station. The low latency and high-update-rate features enable off-board computation for real-time tasks of the robots such as attitude stabilization.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A robotic system, comprising:
(a) a first robot that includes a plurality of motors, a robot transceiver and a battery;
(b) a motion capture system that tracks a position and attitude of the first robot within a coordinate system and that generates position and attitude data representative thereof;
(c) a ground station, including a computer, that is in wireless data communication with the robot transceiver of the first robot and that is in data communication with the motion capture system, the ground station configured to: receive the position and attitude data from the motion capture system; cause the computer to calculate a desired actuation for the first robot; cause the computer to generate the actuation command data packet to include actuation commands for effecting the desired actuation; and transmit the actuation command data packet wirelessly to the robot transceiver of the first robot, wherein all real-time flight controllers are disposed on the ground station and not on the first robot, the computer programmed to calculate all motor voltage values necessary to accomplish a maneuver and transmit them to the robot transceiver;
(d) a core electronics board affixed to the first robot, the core electronics board including:
(i) an advanced RISC machine (ARM) processor that is responsive to the robot transceiver, wherein the advanced RISC machine (ARM) processor receives the motor voltage values from the ground station and is programmed to determine to which motor each voltage value is to be assigned;
(ii) a plurality of motor controllers, wherein each of the plurality of motors is electrically coupled to the advanced RISC machine (ARM) processor and is electrically coupled to one of the plurality of motor controllers, wherein the advanced RISC machine (ARM) processor transmits a voltage value assigned to a selected motor to the one of the plurality of motor controllers electrically coupled to the selected motor, wherein the one of the plurality of motor controllers electrically coupled to the selected motor applies an activating voltage corresponding to the voltage value directly to one of the plurality of motors; and
(e) a power module that provides constant voltage to the entire first robot when voltage from the battery varies over time.

2. The robotic system of claim 1, wherein the first robot includes at least one sensor that is in data communication with the robot transceiver and wherein the robot transceiver is configured to transmit sensor data from the sensor to the ground station.

3. The robotic system of claim 1, wherein the ground station comprises:
(a) a ground transceiver unit that is in wireless communication with the robot transceiver; and
(b) a computer that is in data communication with the ground transceiver unit, the computer programmed to generate the actuation command data packet and transmit the actuation command data packet to the ground transceiver unit.

4. The robotic system of claim 3, wherein the ground transceiver unit comprises:
(a) a radio frequency antenna; and
(b) a main circuit board, electrically coupled to the radio frequency antenna, that includes circuitry to interface with the computer and that is configured to transmit the actuation command data packet received from the computer to the robot transceiver via the radio frequency antenna.

5. The robotic system of claim 1, further comprising at least one second robot that is in wireless data communication with the ground station.

6. The robotic system of claim 1, wherein the motion capture system comprises three position sensors that are spaced apart.

7. The robotic system of claim 6, wherein the position sensors comprise motion capture cameras.

8. The robotic system of claim 7, wherein the motion capture cameras have a frame rate of at least 100 frames per second.

9. The robotic system of claim 1, wherein the first robot comprises an aerial robot.

10. The robotic system of claim 9, wherein each of the plurality of motors coupled to a propeller.
